(19) United States
(12) Patent Application Publication
(10) Pub. No.: US 2021/0114873 A1
(43) Pub. Date: Apr. 22, 2021

(54) Method for Manufacturing Mixed Oxide Powders as Well as a Mixed Oxide Powder

(71) Applicant: Glatt Ingenieurtechnik GmbH, Weimar (DE)

(72) Inventors: Michael Jacob, Weimar (DE); Lars Leidolph, Bad Berka (DE); Reinhard Böber, Weimar (DE); Thomas Jaehnert, Jena (DE); Matthias Seidel, Dresden (DE); Kristian Nikolowski, Dresden (DE); Mareike Wolter, Dresden (DE)

(21) Appl. No.: 17/046,413

(22) PCT Filed: Mar. 26, 2019
(86) PCT No.: PCT/EP2019/057520

§ 371 Date: Oct. 9, 2020

(30) Foreign Application Priority Data
Apr. 10, 2018 (DE) 10 2018 205 398.7

(51) Int. Cl. C01B 13/18; C01B 13/34

(52) U.S. Cl. CPC C01B 13/185; C01B 13/34; C01P 2004/38; C01P 2004/62; C01P 2004/61

(57) ABSTRACT

A method for manufacturing mixed oxide powders including the steps (a) producing a raw material mixture, (b) bringing the raw material mixture into a hot gas flow for the thermal treatment in a reactor, (c) forming particles of the mixed oxide powder, and (d) bringing the particles of the mixed oxide powder which are obtained in the step (b) and (c) out of the reactor, wherein the raw material mixture is manufactured in the form of a solution or suspension of at least one salt and/or salt mixture of at least one compound of the elements lithium, nickel and/or manganese, as well as a mixed oxide powder which is manufactured according to this method.

### CROSS-REFERENCE TO RELATED APPLICATIONS

This application is the United States national phase of International Application No. PCT/EP2019/057520 filed Mar. 26, 2019, and claims priority to German Patent Application No. 10 2018 205 398.7 filed Apr. 10, 2018, the disclosures of which are hereby incorporated by reference in their entirety.

### FIELD OF THE INVENTION

The invention relates to methods for manufacturing mixed oxide powders comprising the steps (a) producing a raw material mixture, (b) bringing the raw material mixture into a hot gas flow for the thermal treatment in a reactor, (c) forming particles of the mixed oxide powder, and (d) bringing the particles of the mixed oxide powder which are obtained in the step (b) and (c) out of the reactor.

Furthermore, the invention relates to a mixed oxide powder, in particular particles, manufactured from a raw material mixture in the form of a solution or dispersion of at least one compound of the elements lithium, nickel and/or manganese in a hot gas flow.

### BACKGROUND

Lithium ion batteries since their introduction into the market in the early 1990s are a research focus of industry and universities. Above all, with the changing communication technologies and the demand for small, portable devices, they have become indispensable due to their high energy and power density. For this reason, lithium ion technology has become the most important energy source for electronic and portable devices.

Lithium ion technology also plays a significant role today, for example in the automobile sector. An even higher energy and power density is necessary for application as a car battery, so that the battery achieves the same performance as vehicles which are operated with fuel, in particular with regard to the travel distance per battery charging. Such an increase of the energy and power density is achievable by way of an improvement of the battery system itself and of the components which are used for this. One of the components which is to be improved inasmuch as this is concerned, in order to achieve this object, is the cathode material.

The technological advance in the fields of mobile energy stores demands inexpensive, environmentally friendly and thermally stable lithium ion batteries with a high energy and power density. An improved specific capacity and/or a high potential is necessary, in order to achieve a greater energy and power density.

The European patent specification EP 2 092 976 B1 discloses a method for manufacturing very small particles in a pulsating hot gas flow of a thermal reactor, wherein the particles typically have an average size of 5 nm to 100 μm.

The international patent application WO 2006/076964 A2 relates to a method for manufacturing compact, spherical mixed oxide powders with an average particle size of less than 10 μm by way of pyrolysis, as well as their application as luminescent material, as a base material for luminescent material or as a starting products for the manufacture of ceramics or for the manufacture of high-density, high-strength and possibly transparent bulk material by way of hot-pressing technology.

The international patent application WO 2007/144060 Al describes a method for manufacturing garnet luminescent materials or their precursors with particles of an average grain size of 50 nm to 20 μm via a multistage thermal method in a pulsation reactor.

### SUMMARY

The disadvantage of the known methods is the fact that optimal cathode material, with the particles of the mixed oxide powders simultaneously having a low quantity of contamination phases, a low manganese (III) content and a well-shaped idiomorphic crystal shape with a defined crystal size cannot be manufactured on an industrial scale by way of the methods.

It is therefore the object of the invention to develop a method for manufacturing a mixed oxide powder, in order to obtain an optimal cathode material which is capable of manufacturing mixed oxide powder, in particular doped or undoped LiNiyMn2-yO4 (LMNO) on an industrial scale, whilst the particles of the mixed oxide powder simultaneously have a low quantity of contamination phases, a low manganese (III) content and a well-shaped idiomorphic crystal shape with a defined crystal size.

With a method of the initially mentioned type, this object is achieved by way of the raw material mixture being manufactured in the form of a solution or dispersion, wherein the raw material mixture comprises at least one of the elements lithium, nickel and/or manganese. Particularly preferably, the raw material mixture is manufactured in the form of a solution or dispersion, wherein the raw material mixture comprises at least two of the elements lithium, nickel and/or manganese. The method according to the invention provides the advantage that herewith mixed oxide powder, in particular in the form of doped or undoped LNMO powder can be manufactured in a simple and inexpensive manner on an industrial scale. Surprisingly, it has been found that the mixed oxide powders which are manufactured from such a raw material mixture with the method according to the invention simultaneously advantageously have a high electrochemical capacity, preferably greater than 100 mAh/g at 0.1 C, particularly preferably greater than 130 mAh/g at 0.1 C. Furthermore, the mixed oxide powders which are synthesised by way of the method according to the invention particularly preferably have a narrow particle size distribution with particle sizes in the range of 0.5 μm to 100 μm, but particularly preferably between 1 μm and 10 μm. Furthermore, it was found that the LNMO powder, on account of the manufacture by way of the method according to the invention, only has small amounts of contamination phases or impurity phases, a low content of Mn³⁺ ions in the LNMO as well as well shaped crystals with a defined crystal size and shape, preferably of an idiomorphic crystal shape.

The stoichiometric compositions of the mineral phases, as also in nature, are often simplified main chemisms of a mineral type which do not always need to correspond to the exact chemism of the mineral individual. In contrast, differences occur due to the crystal imperfections in the mineral lattice. These differences partly lead to changed characteristics which in technology are utilised in a targeted manner by way of the manufacture of doped phases. By way of the addition of doping elements, such doped mineral types can be generated via the method according to the invention. According to an embodiment of the method according to the invention in regard to thus, in step (a) dopants, in particular from the elements magnesium, aluminium, titanium, vanadium, chromium, iron, cobalt, copper, zinc, silicon, zirconium, ruthenium, rhodium, palladium, silver, platinum, can be added to the raw material mixture. In the crystal structure, preferably in the preferably forming spinel structure, the foreign atoms form crystal imperfections in the mixed oxide powder, by which means the characteristics can be changed in a targeted manner, i.e. the behaviour of the electrons and thus the electrical conductivity. The foreign atoms can herein also assume the crystal spaces of Ni and Mn. Furthermore, the foreign atoms (doping atoms) however can also stabilise the desired structure type. It is already with a very slight foreign atom density that a very large change of the electrical and electrochemical characteristics can be effected.

For forming the raw material mixture, in step a) firstly at least the elements in the form of raw material components which are necessary for forming the particles with the desired chemism are combined into a raw material mixture in the required stoichiometric ratio. By way of the manufacture of a stoichiometric raw material mixture, it is ensured that all raw materials react with one another into particles of a mixed oxide powder and the mixed oxide powder comprises exclusively the same particles. Inorganic and/or organic substances such as for example nitrates, chlorites, carbonates, hydrogen carbonates, carboxylates, alcoholates, acetates, oxalates, citrates, halogenides, sulphates, metal-organic compounds, hydroxides or combinations of these substances are considered as raw material components. The raw material mixture likewise comprises organic or inorganic solvents or further fluid components, wherein at least two fluid phases cannot be mixed with one another in the case of a dispersion or an emulsion.

In a particularly preferred embodiment, at least one salt and/or salt mixtures of the elements lithium, nickel and/or manganese is used for forming the stoichiometric raw material mixture. Herein, what is advantageous is that the salts are typically distinguished by low raw material costs.

The raw material mixture in step (a) is preferably produced as a stoichiometric raw material mixture.

Additionally, a single-stage or multi-stage wet-chemical intermediate step, in particular in the form of a co-precipitation or hydroxide precipitation is carried out in the reactor preferably before the thermal treatment. By way of this, a particularly narrow and defined grain distribution of the particles can be achieved. Moreover, the particle size can firstly be set in the raw material mixture via the type and manner and the process control of the wet-chemical intermediate step, for example via a so-called co-precipitation. On setting the particle size, one must take care that it can be changed by the following thermal process. Known methods such as for example co-precipitation or hydroxide precipitation can be applied for the wet-chemical intermediate step of an aqueous and/or alcoholic raw material mixture.

Particularly preferably, the method for manufacturing mixed oxide powders, in particular LNMO powders is spray pyrolysis. By way of spray pyrolysis, the mixed oxide powders according to the invention can be manufactured in a simple and inexpensive manner in a method which is controllable by way of the setting parameters—pressure, flow rate, etc. For this, the manufactured raw material mixture is introduced into a hot gas flow of a spray pyrolysis reactor for manufacturing the doped or undoped LMNO powder, wherein the LNMO particles form in this hot gas flow.

Furthermore, according to the method according to the invention, the raw material mixture is introduced into a pulsating hot gas flow for the thermal treatment in a reactor. The pulsating hot gas flow in the reactor, compared to other methods, in particular has the advantage that a greatly increased heat transfer can be achieved due to the high flow turbulences. This greatly increased heat transfer is decisive for the course of the phase reaction in the material, for a complete conversion of the raw material mixture into LNMO powder within short sojourn times between preferably 0.1 s and 10 s. Furthermore, a thermal treatment in the pulsating gas flow leads to an increased specific material throughput. Preferably, hereby a pressure amplitude and an oscillation frequency of the pulsating hot gas flow can be set in particular independently of one another. By way of an independent setting of the parameter settings—pressure amplitude and oscillation frequency—the characteristics and in particular the electrochemical characteristics of the mixed oxide powder, in particular of the doped or undoped LNMO powder can be set even better.

The hot gas flow for the thermal treatment of the raw material mixture in a reactor has temperatures between 200° C. and 2500° C., preferably between 400° C. and 2000° C., particularly preferably between 600° C. and 1500° C., very particularly preferably between 700° C. and 1200° C. The mixed oxide powders, in particular the doped or undoped LNMO powders can be manufactured with the improved electrochemical characteristics of a higher energy and power density, in particular with an optimised specific capacity and/or a high potential, by way of the thermal treatment of the raw material mixture. It is possible to manufacture the preferred unordered spinel structures at the very particularly preferred applied temperatures between 700° C. and 1200° C. The preferred unordered spinel structures are characterised in that these provide the preferred electrochemical characteristics with an improved stability compared to ordered spinel structures.

In a preferred embodiment, the pulsating hot gas is produced via a flameless combustion, which is to say that a continuous combustion of the combustion gas in the visible form of a flame does not take place. In contrast, a periodic explosive-like combustion without the formation of a flame is effected byway of the periodic release of the combustion gas and the subsequent ignition. The frequency of the pulsating hot gas flow cannot be influenced or set in a direct manner (self-regulating system) with this type of generation, but only indirectly. The important influencing variables on the frequency of the pulsating hot gas flow are for this the geometry of the reactor (Helmholtz resonator), type and quantity of the raw material mixture as well as process temperature. The advantage of this embodiment is the fact that the equipment for generating the pulsating hot gas flow via this type of generating is comparatively simple and thus inexpensive.

In another preferred embodiment, the raw material mixture is brought into a pulsating hot gas flow, wherein the pulsating hot gas flow is generated by a combustor flame of a combustor with a periodic pressure oscillation with variably settable pressure amplitudes and oscillation frequency. The advantage of this technology for generating the hot gas flow is that the frequency and amplitude can be set in wide ranges.

A cooling gas is advantageously fed to the hot gas flow before step (d). The thermal treatment and hence also the reaction can be interrupted or stopped by way of the feed of cooling gas, in particular air or cooling air. Herewith, the reaction can be stopped at a precisely defined point in time by way of such a method step. Apart from the cooling gas, a water injection into the hot gas flow can also take place, by which means the reaction is likewise interrupted or stopped.

The particles which are obtained in step (b) and (c) are separated from the hot gas flow for bringing these out, preferably by way of a filter, particularly preferably by way of a bag filter, metal filter or glass fibre filter.

According to an additional advantageous embodiment of the method according to the invention, the particles which are obtained from the reactor are subjected to a post-treatment, in particular at least to a grinding and/or at least to a thermal post-treatment, in particular to a post-calcination. By way of this, the electrochemical characteristics of the manufactured metal oxide is improved yet further. Preferably, the particles which are obtained from the reactor are subjected to a thermal post-treatment, in particular to a post-calcination, particularly preferably firstly at least to a grinding and subsequently at least to a thermal post-treatment, in particular to a post-calcination. The degree of crystallisation of the particles of the LNMO powder can be improved and simultaneously the share of undesirable contamination phases and impurity phases can be reduced by way of the thermal post treatment. Furthermore, crystal planes, preferably in the form of octahedrons form by way of the thermal post-treatment, in particular post-calcination.

Furthermore, given a mixed oxide powder of the initially mentioned type, this object is achieved by way of the mixed oxide powder, in particular in the form of LiNiyMn2-yO4 particles, being manufactured in a hot gas flow from a raw material mixture in the form of a solution or dispersion, wherein the raw material mixture comprises at least one of the elements lithium, nickel and/or manganese. Partially preferably, the mixed oxide powder is manufactured in a hot gas flow from a raw material mixture in the form of a solution or dispersion, wherein the raw material mixture comprises at least two of the elements lithium, nickel and/or manganese. The mixed oxide powder according to the invention, preferably a LNMO powder, additionally has the advantage that it is manufacturable in a simple and inexpensive manner. Advantageously, mixed oxide powders which are manufactured from such a raw material mixture have a high electrochemical capacity, preferably larger than 100 mAh/g at 0.1 C, particularly preferably larger than 130 mAh/g at 0.1 C. Furthermore, the mixed oxide powders which are manufactured by way of the method according to the invention preferably have a mono-modal particle size distribution with preferred particles sizes in the range of 0.5 μm to 100 μm, particularly preferably between 1 μm and 10 μm. The LMNO powder according to the invention preferably has a cubic crystal system, in particular in the form of a space group Fd-3m or P4332.

The mixed oxide powder is preferably manufactured according to a method as described herein.

### BRIEF DESCRIPTION OF THE DRAWINGS

The invention is hereinafter explained in more detail by way of the attached drawings. In these are shown in:

FIG. 1 a powder diffraction diagram (XRD diagram) of all LiNi0.5Mn1.5O4 particles in a 2θ-region of 10° to90°,

FIG. 2 a powder diffraction diagram (XRD diagram) of all LiNi0.5Mn1.5O4 particles in a 2θ region of 35° to 70° with LixNi1-xO phase impurities which are highlighted in black boxes,

FIG. 3 FESEM pictures for the different LiNi0.5Mn1.5O4 particles,

FIG. 4 the particle size distribution of the different LiNi0.5Mn1.5O4 particles,

FIG. 5 an overview over the specific surface area and the particle size distribution (d90) of LiNi0.5Mn1.5O4 particles,

FIG. 6 rate capability and ageing test results for LiNi0.5Mn1.5O4 particles,

FIG. 7 an overview over the specific surface area, correlated with the specific discharge capacity at a 0.1 C-rate, and particle size distribution (d90) of LiNi0.5Mn1.5O4 particles,

FIG. 8 discharge curves of LiNi0.5Mn1.5O4 particles at 0.1 C,

FIG. 9 cumulative end point capacities of LiNi0.5Mn1.5O4 particles, (charging: full symbol; discharging: empty symbol) which are measured during galvanostatic cyclisation,

FIG. 10 a correlation between specific surface area and cumulative discharge of LiNi0.5Mn1.5O4 particles,

FIG. 11 an impedance measurement of LiNi0.5Mn1.5O4 particles given a state of charge (SOC) of 90%,

FIG. 12 an equivalent circuit diagram for the electrochemical impedance spectroscopy (EIS) adaptation,

FIG. 13 values for the surface film resistance (Rsf) plotted against the state of charge (SOC), said values having been determined by analysis of the EIS measurements,

FIG. 14 values for the charge transfer resistance (Rct) plotted against the state of charge (SOC), said values having been determined by analysis of the EIS measurements;

FIG. 15 values for the electrolyte resistance (Re) plotted against the state of charge (SOC), said values having been determined by analysis of the EIS measurements,

FIG. 16 a correlation between the specific surface area space and surface film resistance (Rsf) of the LiNi0.5Mn1.5O4 particles.

### DETAILED DESCRIPTION

On account of the high potential versus lithium, spinel LiNi0.5Mn1.5O4 (LNMO) is a promising candidate amongst other high-potential materials, in order to fulfil the demands of technological progress, in particular in order to achieve a higher energy and power density. LNMO has a dominant potential plateau at 4.7 V versus Li/Li⁺ and the theoretical specific capacity of 147 mAh/g. Furthermore, LNMO can significantly reduce the raw material costs which occur on manufacture and has a reduced toxicity compared to cathode materials based on cobalt. The spinel structure exhibits a high structural stability due to isotropic expansion and contraction during intercalation. Depending on the distribution of the nickel and manganese atoms, LNMO can form two space groups with an ordered and unordered crystal structure. In the ordered structure (space group of the primitive cubic structure P4332), Ni and Mn atoms have the position 4a and 12d, whereas in the unordered structure (space group of the surface-centred cubic structure Fd3m) both types of atoms are randomly distributed onto the octahedral positions 16d.

The electrochemical performance of this cathode material is predominantly dependent on two parameters, the presence of LiyNi1-yO rock-salt phase (foreign phase) and the quantity of Mn³⁺ ions. It is difficult to synthesise a pure LNMO phase with a controlled morphology due to the undesired particle growth of foreign phases during the sintering process at high temperatures. The formation of the unordered LNMO is usually accompanied by the formation of a rock salt phase which however reduces the achievable capacity of the cathode material. For this reason, it is important to reduce the formation of the rock salt phase to a minimum, so that the manufactured LNMO particles have little as possible contamination phases.

A further challenge is the control of the content of Mn³⁺ ions in the crystal. If for example the quantity of Mn³⁺ ions in the crystal is too high and two Mn³⁺ ions interact, an Mn²⁺ ion and a redox-inactive Mn⁴⁺ ion form. This reaction is denoted as a disproportionisation reaction. Furthermore, the Mn²⁺ ion is soluble in the electrolyte and the Mn⁴⁺ ion is stable and electrochemically active. This leads to a poor performance of ordered LNMO and to a loss in capacity. The conductivity of the unordered LNMO is amplified by small quantities of Mn³⁺ ions and hence exhibits an improved rate capability. The diffusion of lithium ions depends on the composition and morphology of the LNMO. The synthesis of the specific space groups of LNMO depends on the calcination temperature. The calcination temperature must lie at about 700° C. in order to obtain the ordered spinel structure, whereas temperatures of 700° C. and more are necessary for unordered spinel structures.

In the series of trials which were carried out, the unordered LNMO crystal structure was synthesised, since in literature it has been found that it has improved electrochemical characteristics and an improved stability compared to the ordered crystal structure.

In the series of trials, mixed oxide powder in the form of LNMO with an unordered crystal structure was synthesised by way of different manufacturing methods. The first synthesis method is based on a spray drying method, the second synthesis method on a manufacturing method similar to spray pyrolysis. In both manufacturing methods, the LNMO particles are produced in a hot gas flow which flows through the reactor and are separated out of this after synthesis, for example by way of a separating device. Furthermore, the LNMO powder which was manufactured by the two synthesis methods was subjected to a post-treatment. As a post-treatment, on the one hand a single-stage thermal post-treatment (1) and on the other hand a two-stage mechanical and thermal post-treatment (2) were carried out:

With the single-stage thermal post-treatment, the precursor was firstly heated at 1K/min to 200° C., followed by 5 K/min to800° C. and subsequently treated further at a temperature of 800° C. for 5 hours amid air in a muffle furnace. After the five-hour treatment time, the mixed oxide powder in the form of LNMO particles was cooled overnight in the furnace.

In the case of the two-stage mechanical treatment, firstly a grinding step with a grinding of the LNMO particles for 1 hour in a planet ball mill (company FRITSCH GmbH) with EtOH as a grinding medium and subsequently a thermal post treatment in a muffle furnace were carried out. With the thermal post-treatment, the LNMO particles were heated at 1 K/min to 200° C. followed by 5 K/min to 800° C. and subsequently treated further for duration of 5 hours. The mixed oxide powder was cooled overnight in the furnace after the treatment time.

Table 1 shows the mixed oxide powder, in particular LiNi0.5Mn1.5O4 particles (LNMO) which is manufactured according to a method according to the invention. Hereby, the particles which are manufactured by way of the pulsating gas flow are characterised by the abbreviation AT, and the particles which are manufactured by way of the spray drying by the abbreviation ST. The particles which are manufactured by way of the two aforementioned method and which have been synthesised on the basis of a suspension are marked by S and those on the basis of a solution are marked by L. If the synthesised particles have undergone no additional temperature treatment, then the particles are characterised by 0, in the case of an additional 5-hour temperature treatment are characterised by 5 and in the case of an additional 5-hour temperature treatment with a prior 1-hour grinding step by 5g.

TABLE 1
examined LNMO particles which are synthesized
according to different manufacturing methods

| | APPtec | APPtec | Spray |
|---|---|---|---|
| | (solution) | (suspension) | drying |
| without post-treatment | AT_L_0 | AT_S_0 | ST_L_0 |
| temperature post-treatment | AT_L_5 | AT_S_5 | ST_L_5 |
| (5 h at 800° C.) | | | |
| grinding (1 h) and | AT_L_5g | AT_S_5g | ST_L_5g |
| temperature post-treatment | | | |
| (5 h at 800° C.) | | | |

The APPtec method is a method which has been developed by the company Glatt Ingenieurtechnik, with which precursors are sprayed into a pulsating gas flow in different manners, for example on the basis of a solution or suspension, with an adjustable droplet size distribution. The pulsating gas flow generates special thermodynamic reaction conditions in a reactor, these giving the manufactured powders advantageous characteristics. The desired chemical and mineralogical reaction takes place by way of the defined thermal treatment, and particles form. The duration of the thermal treatment of the sprayed-in raw material mixtures is preferably less than 10 seconds.

A homogeneous precursor was manufactured for the synthesis of LNMO by way of spray drying and this was subsequently regulated in temperature for forming the suitable crystal phase. The raw material mixture was manufactured by way of dissolving stoichiometric quantities of CH3COOLi H2O (99%, Sigma-Aldrich), Ni(CH3COO)2 4 H2O (99%, Sigma-Aldrich) and Mn(CH3COO)2 4 H2O (99%, Sigma-Aldrich) in ethanol. The solution was sprayed into a Büchi Mini Spray Dryer B-290 for manufacturing the precursor.

The mixed oxide powders in the form of LMNO, developed with the aforementioned methods and possibly amid post-treatment were characterised and tested, in order to understand the influence of the different synthesis methods upon the electrochemical performance.

Undesirable reactions occur in the cell due to the high voltage and these represent a huge challenge for the commercialization of this high-voltage cathode material. These lead to a decomposition of the electrolyte, to a lower Coulomb efficiency and to an increase of the internal resistance over the complete cycle and hence influence the service life of the battery to a significant extent. The cumulative end point shift capacity and the electrochemical impedance spectroscopy (EIS) were examined, in order to measure and characterise the degree of undesirable reactions in the cells.

The performance analysis and the results of the cumulative specific capacity exhibit the fluctuations of the electrolyte break-down between the materials. EIS technology was used in order to examine the electrode materials, since it can describe the relation between the crystal lattice and the electrochemical characteristics.

The characterisation of the mixed oxide powder in the form of LNMO, manufactured by way of the different methods as described previously, was effected amid the aid of different analyses. The scanning electronic microscope (SEM) pictures were taken whilst using a Crossbeam NVISION 40 of Carl Zeiss SMT with an Everhart Thornley detector. X-ray diffraction (XRD) data was measured amid the use of a Bruker D8 diffractometer with a CuKα radiation (0.154056 nm). The electrodes for the electrochemical measurements were manufactured by way of pouring a slurry of 80% active material (LNMO), 10% binder (PVDF, Solef) and 10% carbon (Super P, Timical) onto Al foil (Hydro) and was dried for 20 hours at a temperature of 60° C. Cells with a two-electrode construction were provided as half-cells versus metallic lithium. A Whatmann glass fibre disc was used as a separator and LP40 (1M LiPF6 in EC:DEC 1:1 w/w BASF) was used as an electrolyte. The joined-together button cells LNMO/Li were galvanostatically cycled between 3.5 V and 5.0 V. All electrochemical measurements were carried out at 30° C. amid the use of a BASYTEC cell testing system. Five button cells were provided for each material, in order to obtain a reliable average. The button cells which were used for the galvanostatic measurement were likewise used for the EIS measurement. EIS was created with the Gamry-Framework Version 6.25, integrated with Basytec CTS at 30° C. The EIS measurements were carried out at

10 mV interference amplitude in the range of 100 kHz to 1 Hz in automatic sweep mode from high to low frequencies. The counter-electrode is large enough so that it does not significantly influence the EIS behaviour of the operating electrode. The impedance was measured at a state of charge (SOC) of 90%, 60%, 30% and 10%. The potential was stabilised for 2 hours before the impedance was applied at each SOC. The produced impedance was further adapted amid the use of the function ZfitGUI (Varagin) of Matlab whilst using the equivalent circuit diagram which is shown in FIG. 12.

The results are represented and discussed hereinafter by way of diagrams.

XRD measurements were carried out in order to determine whether the Spinel phases were formed by the different synthesis methods. X-ray diffraction (XRD) is a unique method for examining the crystallinity of a substance. XRD is mainly applied for these questions:

Proof of identity of crystalline material (for official use or in development)

Proof of identity of different polymorphous shapes (“fingerprints”)

Differentiation between amorphous and crystalline material

Quantification of the percentage crystallinity of a particle.

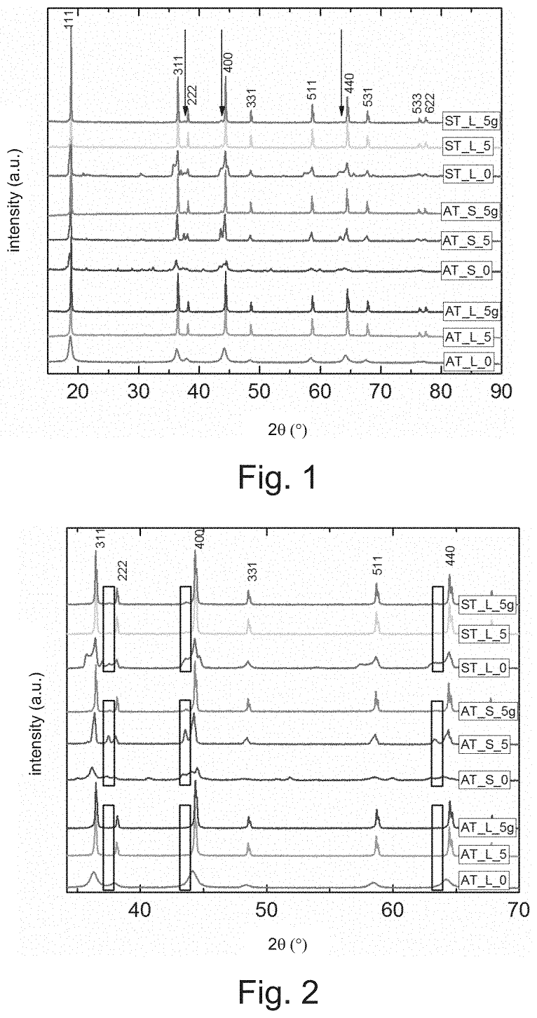

The crystal imperfection of LNMO is related to the formation of oxygen vacancy sites which occurs when the particles are thermally treated at increased temperatures of more than 700° C. FIG. 1 shows the powder diffraction diagrams of all manufactured LNMO particles according to Table 1. The reflections of the crystal planes are highlighted in FIG. 1 and are characteristic of the LNMO crystal phases. It has been found that the particles have a different phase purity depending on their synthesis. The particles without an additional calcination either exhibit a low crystallisation, characterised by wide reflections with a low intensity for the LNMO particles which are manufactured in the pulsating hot gas flow (AT_L_0 and AT_S_0), or a large number of reflections, wherein these are not down to the reflections of the spinel phase which by way of their indices are specified for LNMO particles (ST_L_0) which are manufactured by way of spray drying. The weak reflections at 37.5°, 43.7° and 63.7° indicate impurities which are common and are also described in the literature and are marked by arrows and can be assigned to the rock salt phase LiyNi1-yO. These are often verified with the unordered LNMO crystal structure.

By way of applying an additional thermal treatment in the form of a calcination, it was possible to improve the crystallisation of the particles of the mixed oxide powder. This on the one hand is visible by way of the change of the solution-based LNMO particles which are manufactured in the pulsating hot gas flow, in comparison between untreated particles (AT_L_0) and treated particles (AT_L_5) and on the other hand by way of the reduction of the undesired phases for the other particle s (AT_S_5, ST_L_5) compared to the untreated versions (AT_S_0, ST_L_0).

For further improving the material characteristics, the LNMO particles were ground in a planetary ball mill for one hour before the second temperature treatment. The changes of the intensity curves with respect to the contamination phases are highlighted in FIG. 2 by boxes. It is shown that the additional treatment has a significant influence on some materials. In particular, as is illustrated in FIG. 2, the suspension-based particles (AT_S) which are manufactured in the pulsating hot gas flow exhibit a significant change in the intensity of the contamination phase. By way of the treatment, the contamination quantity for these particles was reduced (AT_S). A change for the other particles by way of the grinding was not ascertained. The reduction of the contamination phase was effected on account of the improved oxygen contact with the surface of the particles. The oxygen is necessary in order to integrate the rock salt phase back into the spinel structure. For this reason, the calcination together with the grinding improve the crystallisation once again.

It has been found that preferably more time is necessary in order for the crystals to be able to form and grow. Whereas the influence of the grinding on the solution-based particles (ST_L and AT_L) which only have low quantities of the rock salt phase is low, the additional grinding step exhibits a further improvement for particles with a high quantity of rock salt phase (AT_S_5). These phases are subjected to oxygen in an improved way and manner due to the grinding. FIG. 1 as a whole for the particles (*_5g) post-treated in a two-stage manner shows a low quantity of contamination phases.

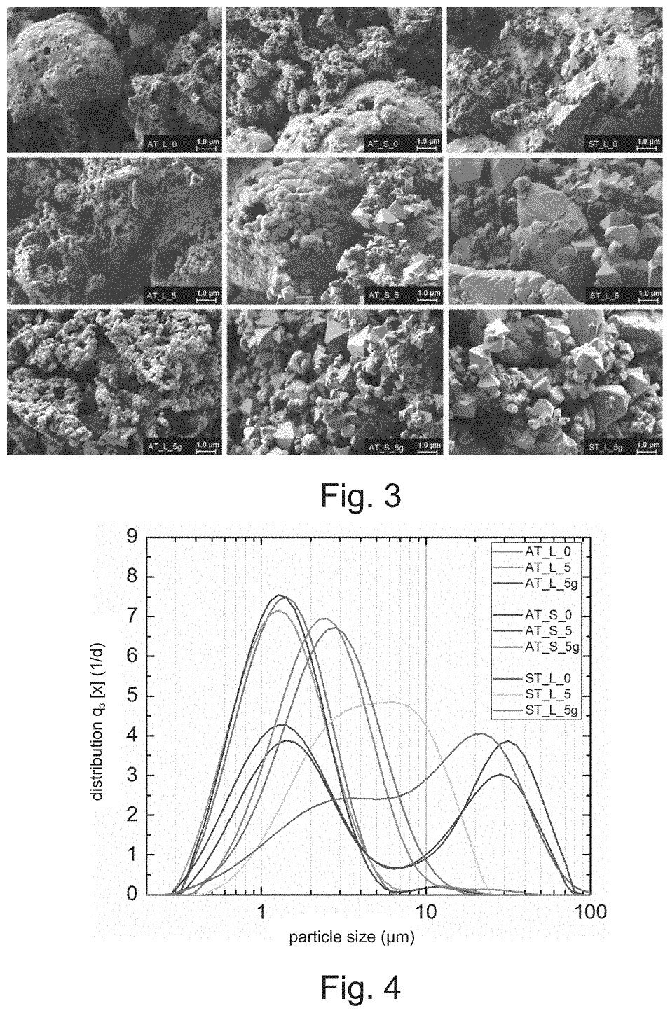

FIG. 3 shows pictures of field emission scanning electron microscopy (FESEM) for all nine samples. The difference with regard to crystal morphology, crystal size and crystal make-up was examined by way of the FESEM pictures.

FIG. 3 shows that an additional calcination has a significant visible influence on the LNMO particles. Without thermal treatment, no crystal planes for the particles (AT_L, AT_S) manufactured in the pulsating hot gas flow can be recognised. In contrast to this, a few crystal planes are visible for the spray-dried LNMO particles (ST_L), wherein however a pure crystal is not to be found.

It is represented in FIG. 3 that crystals are formed by way of the single-stage post-treatment in the form of an additional calcination of the LNMO particles after the 5-hour thermal treatment. Furthermore, the materials exhibit different crystal shapes. The LNMO particles which are produced in the pulsating hot gas flow exhibit smaller crystals, and it is particularly the solution-based precursors which comprise (AT_L_5) crystals after an additional temperature treatment, wherein the particle size of the crystals is about 0.1 μm.

The particle size is around 1 μm for the suspension-based LNMO particles (AT_S_5) which are manufactured in the pulsating hot gas flow with a single-stage post-treatment, whereas even larger crystals with a particles size of greater than 1 μm are exhibited by the particles (ST_L_5) which are manufactured by way of spray drying given the same treatment. Pure crystal planes are recognisable after a single-stage post-treatment and the LNMO particles mostly form crystal in the form of octahedrons.

Furthermore, the FESEM pictures show no significant changes for the LNMO particles with a 2-stage post-treatment. The mechanical post-treatment in the form of a grinding step therefore only has little influence on the crystal size. The mechanical post-treatment has a greater influence on the aggregation and agglomeration if the LMNO particles.

As a whole, it is ascertained that an additional 5-hour temperature treatment is necessary in order to form crystals and assist in their growth. It is exclusively the suspension-based LNMO particles (AT_S) which are manufactured in the pulsating hot gas flow and LMNO particles (ST_L) which are manufactured by way of spray drying which have the preferred shape of spinel, the octahedron. This means that the metal ions distribute in a uniform manner during the temperature treatment, in order to form the preferred crystal planes.

FIG. 4 shows the particle size distribution of all particles and their change by way of the different post-treatments.

It can be recognised that for the solution-based LNMO particles (AT_L) which are manufactured in the pulsating hot gas flow, no changes in the particle size distribution occur due to a post-treatment. The suspension-based LNMO particles (AT_S) which are manufactured in the pulsating hot gas flow exhibit different particle size distributions. Two particles sizes, specifically around 1 μm and around 30 μm manifest themselves without post-treatment (AT_S_0) and with a single-stage post-treatment (AT_S_5). By way of the mechanical post-treatment in the form of the grinding (AT_S_5g), the particle size distribution is unified at a particle size of around 2.5 μm. Hence the solution-based LNMO particles which are manufactured in the pulsating hot gas flow have a narrower particle size distribution than the suspension-based LNMO particles which are manufactured in the pulsating hot gas flow. A change of the particle size distribution is shown in the same manner for the spray-dried LNMO particles (ST_L). This being from a wide distribution with two peaks for the untreated particles of the LNMO particles (ST_L_0) to a much narrower distribution with a peak on account of the 2-stage post-treatment (ST_L_5g). The post-treatment breaks up aggregates and thus leads to a more homogeneous particle size distribution.

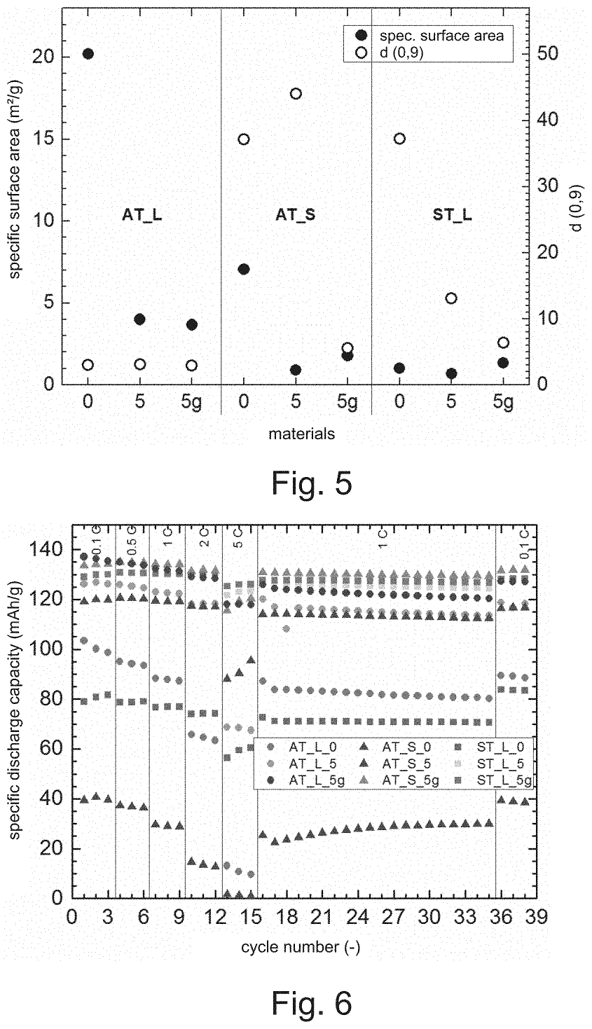

The d90 diameter and the specific surface area which was determined via the BET method are shown in FIG. 5. The results are represented in three columns for the different methods (AT_L, AT_S, ST_L) and per column for the three different types of post-treatments (0, 5, 5g).

The particle size distribution (d90) is the same for solution-based particles of the LNMO particles (AT_L) which are manufactured in a pulsating hot gas flow. A change can be recognised in the specific surface area. The specific surface area of the LNMO particles is greatly reduced from 20 m²/g to 4 m²/g by way of the single-stage post-treatment in the form of an additional calcination. No significant change in comparison to the single-stage post-treatment is achieved by way of the 2-stage post-treatment.

The d90 diameter lies at round 40 μm for LNMO particles which were subjected to no or a single-stage post-treatment. In contrast to this, the d90 diameter for LNMO particles which were subjected a 2-stage post-treatment lies at around 5 μm. For the suspension-based particles (AT_S) which are manufactured in a pulsating hot gas flow, the specific surface area without an additional treatment (AT_S_0) at 7 m²/g in comparison is lower than in the case of solution-based particles (AT_L_0). By way of a single-stage post-treatment (AT_S_5), the specific surface area is reduced to 1 m²/g and by way of a 2-stage post-treatment to 2 m²/g.

The spray dried particles as a whole have specific surface area values around 1-3 m²/g. The particle size distribution (d90) reduces from no post-treatment (ST_L_0) via a single-stage post-treatment (ST_L_5) to a 2-stage post-treatment (ST_L_5g) from 38 to 6.

The additional grinding (*_5g) has an influence on the particle size distribution, wherein the specific surface areas remain the same. Considered as a whole, a post-treatment leads to a reduction of the particle size distribution and of the specific surface area.

The measurement of the particle size distribution (laser diffraction) and of the specific surface area (BET) do not provide any information on the individual surface of the primary particles; in contrast the results shows the aggregation and the agglomeration of the particles. The particles (AT_L, AT_S) which are produced by way of the method of a pulsating hot gas flow exhibit a high specific surface area without post-treatment. A recognisable crystal growth does not take place, which is why the specific surface area continues to remain large, since the structure for the most part is influenced by way of the fine distribution during the spraying procedure. The crystals begin to shape and the specific surface area reduces on account of the thermal post-treatment. No significant change is perceived for the spray-dried particles (ST_L) since the crystals have already been shaped. In contrast, the change in the particle size distribution is very different. It should be noted that the LNMO particles have been treated differently for the analysis methods. The powder was dissolved in a solution for the particle size distribution. Agglomerates were broken up and for this reason differences in the BET method could be recognised where agglomerates continue to exist. The particle size distribution did not change for the solution-based particles (AT_L) which are produced in the pulsating hot gas flow, wherein the agglomerates were destroyed by way of the post-treatment. The suspension-based particles (AT_S_5) which are manufactured in a pulsating hot gas flow and having a single-stage post-treatment exhibit no significant differences in the particle size in comparison to the untreated particles (ST_L_0). The particle size could be reduced exclusively by way of a 2-stage post-treatment, in particular by way of the grinding step which breaks up the aggregates. With regard to the specific surface area, the characteristics of the suspension-based particles (AT_S) are similar to those of the solution-based particles (AT_L), which leads to a similar conclusion with regard to the formation of the crystals. For the spray-dried particles (ST_L), a temperature post-treatment leads to smaller crystals. This can be explained by the fact that larger aggregates form smaller crystals. This change is additionally shown in the FESEM pictures in FIG. 3.

The electrochemical characterisation and the galvanostatic cycle characteristics are shown in the FIGS. 6 to 8 and Table 2. The battery power and the cycle stability over different C-rates were characterised with the galvanostatic method. A discharge current with a rate of “1 C” herein corresponds to the current which is necessary in order to discharge the battery cell in one hour. Accordingly for example, a discharge current of “2 C” corresponds to a current which is necessary in order to discharge the battery cell in half an hour and a discharge current of “½C” or “0.5 C” corresponds to a current which is necessary to discharge a battery cell in two hours.

The rate capability is shown for all LNMO particles in FIG. 6. The particles exhibit a significant difference in the specific capacity at the measured C-rates. By way of a single-stage post-treatment in the form of an additional calcination, the values are improved significantly, as is shown in FIG. 6. The grinding step, the 2-stage post-treatment also has a positive influence on the specific capacity. However, one can also recognise that the increase of the specific capacity is different for different particles. It is particularly the suspension-based particles (AT_S_0) which are manufactured in the pulsating hot gas flow which at 41 mAh/g have a very low capacity without an additional post-treatment, whereas the solution-based particles of LNMO (AT_L_0) which are manufactured in the pulsating hot gas flow and the spray dried particles (ST_L_0) already have 100 mAh/g and 81 mAh/g respectively.

After a thermal treatment for the suspension-based LNMO particles (AT_S_5) which are manufactured in a pulsating hot gas flow, the specific capacity can be more than doubled from 27% to 60%, which is likewise the case for solution-based particles of the LNMO particles (AT_L_5) which are manufactured in a pulsating hot gas flow and the spray-dried particles (ST_L_5).

The additional grinding step which is contained in the 2-stage post-treatment has no influence on the spray-dried particles (ST_L_5g). In contrast to this, this however increases the specific capacity for the particles (AT_L_5g, AT_S_5g) which are manufactured in the pulsating hot gas flow, as is further shown in Table 2. The specific capacity for different C-rates is shown in FIG. 6 and is summarised in Table 2. In general, the LNMO particles which were subjected to a 2-stage post-treatment have a lower capacity loss at increasing C-rates. At 0.1 C, a low electrical charging, the discharge time of the battery permits a complete intercalating of lithium ions in the anode and leads to a maximal utilisation of the battery capacity during the charging/discharging cycles. In contrast to this, at 5 C, a high electrical charging, the rapid discharging times do provide the battery with sufficient time in order to render the maximal capacity usable. This phenomena is exhibited by all particles, but differs significantly with regard to the material characteristics and the manufacturing method of LNMO particles. The capacity correlates to the particle size distribution. The electrolyte is in the position of achieving high quantities of crystalline active material.

| | | capacity | | | | | | |
|---|---|---|---|---|---|---|---|---|
| | spec. | increase | | | | ageing | | |
| | capacity | with post- | 0.1 C | 0.1 C | 0.1 C | after | | Mn3 +− |
| | at 0.1 C | treatment | zu 1 C | zu 2 C | zu 5 C | 20 cycles | 0.1 C | share |
| | [mAh/g] | [%] | [%] | [%] | [%] | [%] | Recyling | [%] |
| AT_L_0 | 100 | — | 12 | 35 | 89 | 5 | 11 | 50 |
| AT_L_5 | 127 | 27 | 3 | 7 | 46 | 3 | 8 | 9 |
| AT_L_5g | 136 | 7 | 3 | 5 | 13 | 3 | 7 | 8 |
| 192 | 41 | — | 29 | 66 | 98 | −30 | 5 | 86 |
| AT_12S_5 | 120 | 192 | 1 | 2 | 24 | 1 | 2 | 47 |
| AT_S_5g | 134 | 12 | 0 | 1 | 10 | 1 | 1 | 23 |
| ST_L_0 | 81 | — | 5 | 9 | 26 | 1 | −4 | 34 |
| ST_L_5 | 130 | 60 | 0 | 0 | 5 | 1 | 1 | 12 |
| ST_L_5g | 130 | 0 | 0 | 0 | 3 | 1 | 1 | 8 |

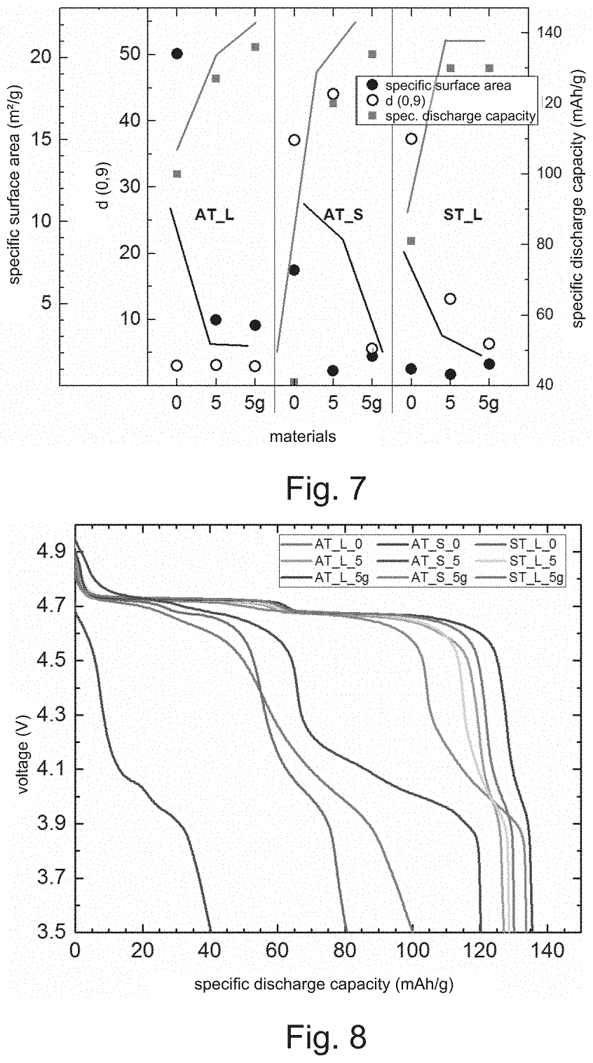

The specific surface area in m²/g and the particle size distribution (d90) is correlated with regard to the measured specific discharge capacity in mAh/g at a rate of 0.1 C in FIG. 7. In order to describe the correlation, the change of the specific surface area and the particle size are represented in a combined manner and as a black line. The change of the specific discharge capacity at 0.1 C is specified by the red line. A reduction of the specific surface area and particle size leads to an increase in the specific discharge capacity. Both material characteristics influence the electrochemical characteristics, as shown, since the specific discharge capacity is very small in the case of a very large specific surface area and particle size. This is particularly recognisable with the particles without post-treatment (*_0). The largest specific discharge capacity is achieved by the particles by an additional grinding step of the 2-stage post-treatment (*_5g), which exhibit values of greater than 130 mAh/g. A small particle size and specific surface area was achieved for these LNMO particles.

Given an increase in the C-rate from 0.1 C to 1 C, the suspension-based particles (AT_S) and the spray-dried particles (ST_L) exhibited no significant reduction of the capacity with additional treatment steps. This likewise applies to an increase to 2 C, wherein here it is only the suspension-based particles (AT_S) which exhibit a small drop of 1-2%. At a C-rate of 5 C, the capacity drops significantly for all particles except for the spray-dried particles (ST_L_5, ST_L_5g) which exhibit the smallest reduction by only 3% and 5% respectively. Table 2 likewise shows the ageing and the specific capacity after the complete program. In this case, the ground particles (ST_L_5g) have only lost 1% of their initial capacity at the end of the trial series (after 38 cycles), which is little compared to the other particles. A large reduction of the capacity was recognized for particles of the LNMO particles which were subjected to no additional calcination (AT_L_0, AT_S_0, ST_L_0). The particles without additional post-treatment are greatly influenced by the increase of the C-rate. The material characteristics of these particles play an important role in the reduction of the specific capacity given an increase of the C-rate. The material with larger crystals exhibits less reduction of the specific discharge capacity than the material with small crystals. The size differences can be recognised in FIG. 3.

This leads to the fact that the LNMO particles with a larger surface and/or with a smaller crystal size assume a greater interaction with the electrolytes during the charging/discharging cycles, which subsequently results in a deterioration of the capacity. The LNMO particles which have a uniform particle size distribution according to FIG. 4 exhibit a lower reduction of the capacity than the LNMO particles with a non-uniform distribution. A more uniform particle size distribution correlates to a reduction of very large crystals which are not suitable for intercalating and de-intercalating lithium. Additionally, in the literature it is noted that an octahedral crystal shape has improved electrochemical characteristics (FIG. 3) in comparison to other crystal shapes. Apart from the material characteristics, the reduction of the specific capacity is also influenced by the different manufacturing methods. If the different post-treatments in FIG. 6 are considered, a reduction of the capacity for spray-dried particles (ST_L) is smaller than for particles (AT_*) which are manufactured in the pulsating hot gas flow. As already mentioned, due to an extended calcination time with spray pyrolysis, an adequate time is made available for forming the crystal planes during the primary calcination (STT_L), this corresponding to the spray drying. In contrast, with the method with a pulsating hot gas flow, the sojourn time in the reactor is very much smaller—less than 10 seconds—which is why a formation of the crystal planes by way of primary calcination does not take place, which subsequently leads to an increased reduction of the specific discharge capacity.

The number of Mn³⁺ ions can be estimated on the basis of the plateau in the voltage region from 3.5 V to 4.5 V of the charging/discharging voltage curves in FIG. 8. It is assumed that given a voltage of 4.5 V, all Mn³⁺ ions which are located in the material are oxidised into Mn⁴⁺ ions. The percentage of Mn³⁺ ions of all particles was computed from FIG. 8 and summarised in Table 2. According to FIG. 8, the LNMO particles (AT_L_0, AT_S_0) which are manufactured in a pulsating hot gas flow comprise very large quantities of 50% to 86% of Mn³⁺ ions which cover more than half the voltage curve in the voltage region between 3.5 and 4.5 V, wherein the voltage plateau at 4.7 V is much more dominant in all other LNMO particles. The LNMO particles which comprise a large number of Mn³⁺ ions (AT_L_0, AT_S_0 and ST_L_0) consequently exhibit a poor energy density. Furthermore, the post-treatments reduce the share of Mn³⁺ ions. The main reason for the grinding step before the additional calcination is to increase the oxygen interaction during the additional calcination. This leads to an improved crystal growth and to the reduction of the quantity of Mn³⁺ ions. The suspension-based particles (AT_S_0) at 86% have a large quantity of Mn³⁺ ions, wherein the other untreated particles (AT_L_0, ST_L_0) comprise a quantity of Mn³⁺ ions of 50% to 34%. Additionally, during the additional calcination, the percentage of Mn³⁺ for suspension-based particles (AT_S_5) was significantly reduced to 46%, for the solution-based particles (AT_L_5) manufactured in a pulsating hot gas flow to 8.5% and for spray-dried particles (AT_L_5) to 11.7%. The additional grinding has a low influence on the reduction of the Mn³⁺ ions in the case of the solution-based particles (AT_L_5g, ST_L_5g), wherein a reduction of more than 50% takes place for suspension-based particles (AT_S_5g) (Table 2). The suspension-based LMNO particles (AT_S) which are manufactured in the pulsating hot gas flow have a larger quantity of Mn³⁺ ions than other particles. The cause of this is the contact surface between the individual precursor particles with oxygen particles being smaller during the calcination in comparison to the solution-based LNMO particles. This leads to a higher Mn³⁺ ion content for suspension-based LNMO particles than for solution-based LNMO particles.

The aforementioned correlations between the material characteristics and electrochemical characteristics shows that an examination of the phenomenon of the electrolyte decomposition is necessary given high voltages (4.7 V vs. Li/Li⁺). The electrolyte decomposition is due to the undesirable side reactions which take place in the cell, which leads to a larger quantity of reduced substances on both electrodes. This effects a block for the lithium ion transport. The undesirable reactions occur in all particles, but differ enormously in regard to the material morphology (crystal presence, crystal size and crystal structure).

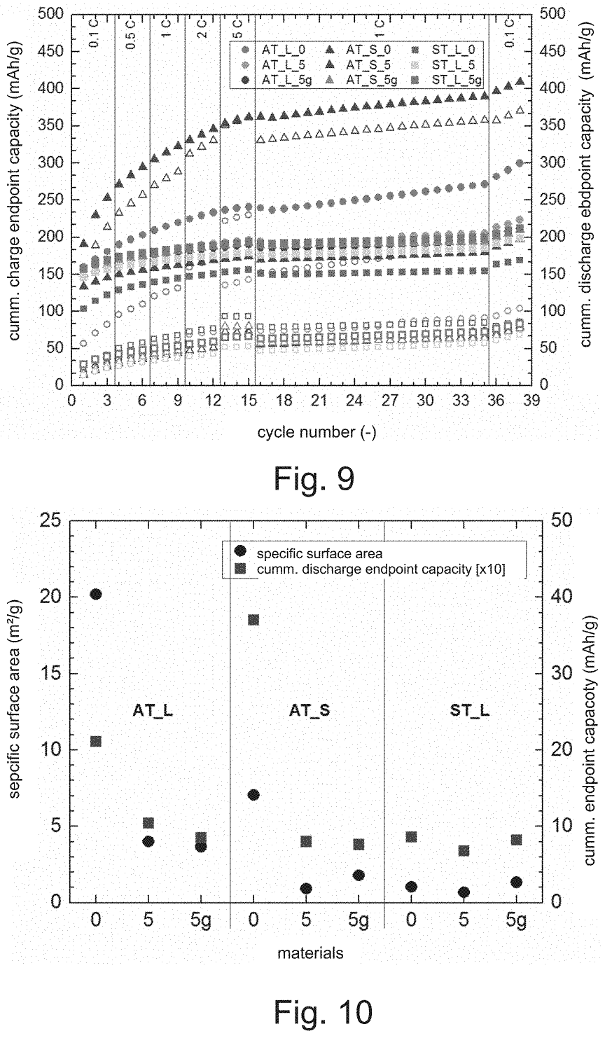

The cumulative charge and discharge end point capacities of all particles which are measured during the galvanostatic measurements are shown in FIG. 9. During the changing loading of the cells, the charging and discharging curves do not exactly correspond due to the parasitic currents, and the curves consequently shift from one cycle to the next. Generally, it can be said that the more the curves shift to the right, the more parasitic currents have flowed. The shifting between the cycles is understood as a capacity shift. The cumulative capacity represents the specific capacity of the respective cycle just as the shifting of each preceding cycle. The value of the cumulative end point capacities increases steeply up to the thirteenth to fifteenth cycle, which belongs to a C-rate of 5 C. The cumulative end point capacity subsequently increases less steeply from the sixteenth cycle to the thirty-eighth cycle.

Although these particles were charged and discharged at different C-rates, the quantity of foreign reactions which occur in the cells continues to be reliably differentiated by way of considering the magnitude of the end point capacities (y-axis) at the end of the cycles. The ratio of the magnitude of the capacity shift (gradient of the curve) is very much larger at the initial cycles (1 to 3) than in the middle and at the end of the cycles, which is most probably due to the formation of the SEI (solid electrolyte interphase) which occurs to a high degree in the initial cycles, by which means the growth rate is then significantly reduced in the subsequent cycles. The size of the foreign reactions is also highly dependent on the contact duration at high voltages of the electrode with respect to the electrolyte. The discussed values after 38 cycles were used for this.

In FIG. 9, the untreated suspension-based particles (AT_S_0) exhibit a very high cumulative discharge end point capacity without an additional treatment of 370 mAh/g whereas the solution-based particles (AT_L_0, ST_L_0) have a value of 211 mAh/g and 86 mAH/g respectively. After an additional calcination, the cumulative discharge end point capacities reduce significantly to 80 mAh/g for suspension-based particles (AT_S_5), to 104 mAh/g for solution-based particles (AT_L_5) which are manufactured in a pulsating hot gas flow and 68 mAh/g for spray-dried solution-based particles (ST_L_5).

The additional grinding has essentially no influence on the cumulative discharge end point capacity for the particles (AT_L_5g, AT_S_5g) which are manufactured in the pulsating hot gas flow, but the cumulative discharge end point capacity increases slightly for the spray-dried particles (ST_L_5g), as is shown in FIG. 9. The same also applies to the cumulative charging end point capacity.

From FIG. 9, it is evident that the cumulative discharge end point capacities behave linearly to the specific surface area of the particles. This lies in the high electrolyte and electrode contact surface when the material has a larger surface. The larger contact surface leads to a larger electrolyte decomposition and subsequently to a greater capacity shift.

FIG. 10 shows the values of the cumulative discharge end point capacities in the magnitude of 10 [×10]. Apart from the specific surface area, the presence of crystals has a great influence on the capacity shift. The spray-dried particles (ST_L) have a reduced capacity shift compared to the other particles (AT_S, AT_L). The reason for this is the presence of crystal planes after the primary calcination. No crystal planes are present after the primary calcination in the case of particles which are manufactured in the pulsating hot gas flow. According to these correlations, it is recommended to keep the crystal size at 1 μm in order to maintain an optimal electrochemical performance and reduced electrolyte decomposition. From this, one can conclude that the electrolyte decomposition is greatly influenced by the specific surface area of the material (FIG. 10). A uniform crystal size distribution and suitable crystal sizes are necessary in order to reduce a deteriorating capacity and the kinetic hindrance.

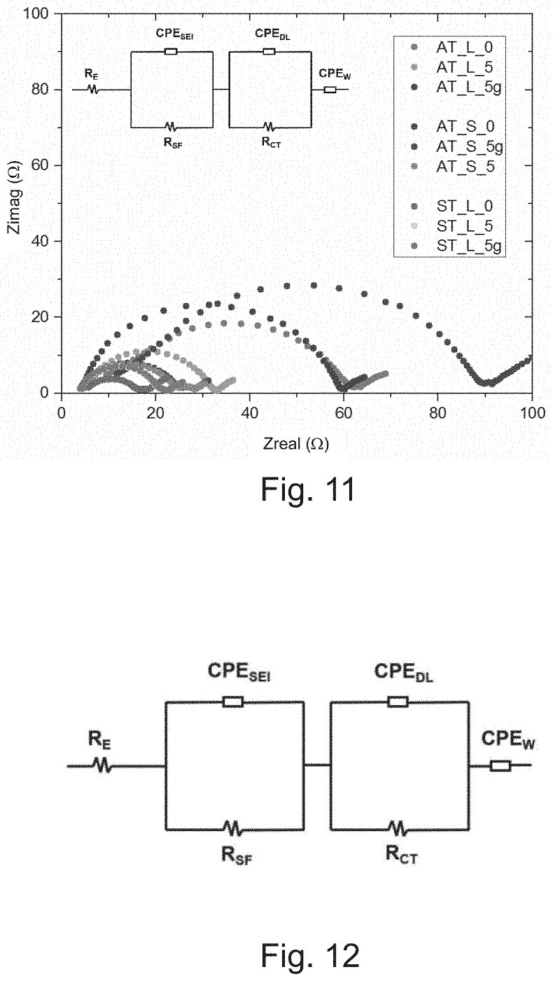

EIS provides information on the kinetic characteristics for the lithium ion transport in the electrodes. The capability of the lithium ion transport controls the kinetic characteristics and the electrode reaction, wherein this factor is greatly influenced by the material morphology. The sequence of the transport also encompasses the lithium ion transport process, the electron transport process and the charge transfer process. On account of the differences in their time constants between these processes, EIS is a suitable technology in order to examine these reactions and can permit such phenomena to be separated. Whilst using EIS and equivalent circuit analyses therefore, one can examine the kinetic parameters which are associated with the lithium ion integration and removal in intercalation materials, such as the surface film resistance, the charge transfer resistance and the electrolyte resistance. The varying impedance was applied at the difference state of charge of the galvanostatically cycled button cells. It is evident from FIG. 11 that the width of the semicircles varies for the materials with a different morphology. All particles at an SOC of 90% differ marginally from the other states of charge. At 90% SOC, the particles ST_L_0 have a very low impedance value without an additional treatment, in comparison to the particles (AT*) which are manufactured in the pulsating hot gas flow. This is down to the presence of crystal planes after the primary calcination, whereas the particles which are manufactured in the pulsating hot gas flow, without additional treatment (AT_L_0, AT_S_0) have no crystals after the primary calcination (FIG. 3). As is shown in FIG. 11, the impedance values are significantly reduced after the post-treatment. According to the interpretation of the material characteristics and electrochemical characteristics, the impendence values are greatly dependent on the crystal size and the crystal size distribution. The particles which have a homogenous crystal distribution and larger crystals (˜1 μm) exhibit reduced impedance values compared to other particles.

In order to further analyse this information with regard to impedances and to understand the correlation between material morphology and the kinetic characteristics, an equivalent circuit analysis was carried out. The information on the electrolyte resistance, the surface film resistance and the charge transfer resistance can be obtained by way of modelling with an equivalent circuit diagram according to FIG. 12.

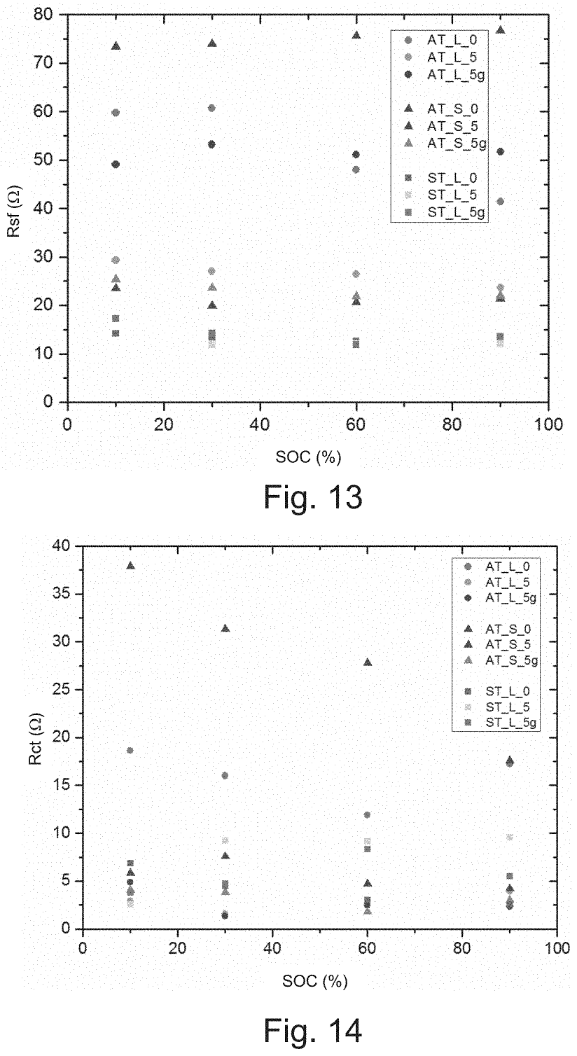

FIGS. 13 to 15 show the results of the adaptation with an equivalent circuit diagram. The electrolyte resonance, the surface film resistance and the charge transfer resistance are the parameters which are considered for the correlation of the material characterises with the kinetic characteristics.

FIG. 13 shows the surface film resistance at different SOCs. The surface film resistance of the material represents the stability of the cathode material surface with respect to the reactive electrolyte. The surface film resistance values differ in accordance with the surface film thickness, and from this interpretation it is possible to estimate the size magnitude of the electrolyte breakdown of different materials. FIG. 13 shows that the surface film resistance (Rsf) at 10% SOC is very much larger than with other SOCs. It is speculated that the passivation film is predominantly formed at the initial SOC and remains almost stable during the SOC increase. FIG. 13 shows that given a SOC of 10%, the spray-dried particles (ST_L_0) have a very low surface film resistance at 14Ω without additional treatment, whereas that of the particles which are manufactured in the pulsating hot gas flow without post-treatment (AT_S_0, AT_L_0) is 73Ω and 59Ω respectively. Furthermore, during the additional calcination, the surface film resistance values for particles which are manufactured in the pulsating hot gas flow are significantly reduced at 23Ω (AT_S_5) and 29Ω (AT_L5) and the spray-dried particles (ST_L_5)/ST_L_5) have a similar value of 17Ω. The grinding step has further reduced the surface resistance, as is shown in FIG. 13. The same interpretation can also apply to other SOCs. The correlation to the specific surface area is illustrated in FIG. 16. Here, it is shown that the reduction of the surface leads to a reduction of the surface film resistance. Generally, from the different electrochemical methods according to Table 2, one can conclude that the magnitude of the foreign reactions in the cell is directly proportional to the specific surface area.

FIG. 14 shows the charge transfer resistance at different SOCs. The charge transfer at an electrode/electrolyte boundary surface is an essential procedure of the charging/discharging reaction of lithium ion batteries. This phenomenon determines the speed of the reactions in the electrode. Generally, the charge transfer values are greatly influenced by the SOC and this phenomenon is varied according to the different particles. FIG. 14 at 90% SOC shows that the untreated spray-dried particles without additional treatment (ST_L_0) have a very low charge transfer resistance of 3Ω, whereas that of the particles (AT_S_0, AT_L_0) which are manufactured in the pulsating hot gas flow in each case is 17Ω. The charge transfer resistance value for the particles (AT_S_5, AT_L_5) which are manufactured in the pulsating hot gas flow has reduced significantly to 4Ω during the additional calcination, and has increased to 9Ω for the spray-dried particles (ST_L_5). The grinding step has further reduced the charge transfer resistance for all particles, as is shown in FIG. 14. The same trend can be applied to other SOCs which are represented in FIG. 14. The charge transfer resistance is directly influenced by the particle size and pore distribution within the electrode layer.

The capability of the charge transfer resistance is controlled by the contact of particle to particle and by way of the continuous crystal network within the electrode layer. And this continuous crystal network provides an improved electrode and electrolyte boundary surface within the porous electrode. As expected, the material without crystals (AT_L, AT_S and ST_L) has a higher charge transfer resistance than the other materials.

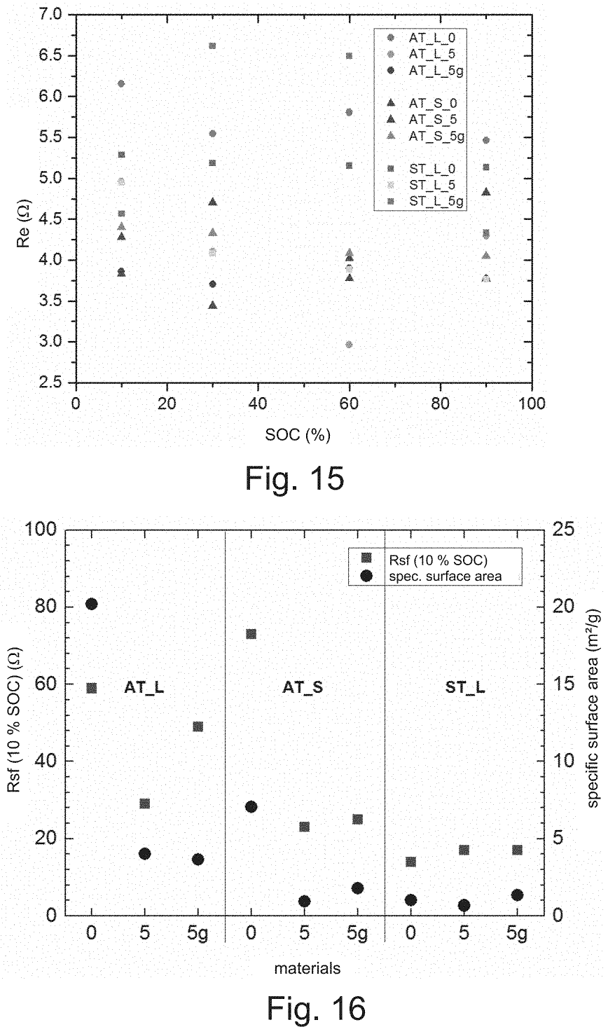

FIG. 15 shows the electrolyte resistance at different SOCs. According to the electrolyte resistance (Re), the conductivity (σ) can be estimated by the thickness of the electrolyte film (electrolyte-impregnated separator thickness 0.052 cm) and by the electrode contact surface to the electrolyte (0.013 cm³). Generally, the electrolyte resistance of all particles lies between 3Ω to 7Ω. According to the results, the electrolyte resistance is predominantly dependent on the particle size of the material and the distribution. Disregarding the material morphology, the difference of the values could be down to the handling of the button cells on construction. When the button cell is put together, there exists the possibility of losing a very small quantity of electrolyte in the inner housing of the button cell.

1. A method for manufacturing mixed oxide powders comprising the steps of:
(a) producing a raw material mixture,
(b) bringing the raw material mixture into a hot gas flow for a thermal treatment in a reactor,
(c) forming particles of the mixed oxide powder, and
(d) bringing the particles of the mixed oxide powder which are obtained in the steps (b) and (c) out of the reactor.
wherein the raw material mixture is manufactured in the form of a solution or dispersion, wherein the raw material mixture comprises at least one of the elements lithium, nickel and/or manganese.

2. The method according to claim 1, wherein the raw material mixture comprises at least two of the elements lithium, nickel and/or manganese.

3. The method according to claim 1, wherein one or more dopants selected from the elements magnesium, aluminium, titanium, vanadium, chromium, iron, cobalt, copper, zinc, silicon, zirconium, ruthenium, rhodium, palladium, silver, and platinum are added to the raw material mixture in step (a).

4. The method according to claim 1, wherein a stoichiometric raw material mixture is produced in step (a).

5. The method according to claim 1, wherein a single-stage or multi-stage wet-chemical intermediate step is carried out in the reactor before the thermal treatment.

6. The method according to claim 1, wherein the method for manufacturing mixed oxide powders is spray pyrolysis.

7. The method according to claim 1, wherein the raw material mixture is introduced into a pulsating hot gas flow for the thermal treatment in the reactor.

8. The method according to claim 7, wherein a pressure amplitude and an oscillation frequency of the pulsating hot gas flow can be set independently of one another.

9. The method according to claim 1, wherein the hot gas flow for the thermal treatment of the raw material mixture in the reactor has temperatures between 200° C. and 2500° C.

10. The method according to claim 1, wherein a cooling gas is fed to the hot gas flow before step (d).

11. The method according to claim 1, wherein the particles are separated from the hot gas flow for bringing the particles which are obtained in steps (b) and (c) out of the reactor.

12. The method according to claim 11, wherein the particles are separated from the hot gas flow at temperatures above 200° C.

13. The method according to claim 1, wherein the particles which are obtained from the reactor are subjected to a post-treatment, wherein the post-treatment is at least a grinding and/or a thermal post-treatment.

14. The method according to claim 13, wherein the particles which are obtained from the reactor are firstly subjected at least to the grinding and subsequently at least to the thermal post-treatment.

15. A mixed oxide powder in the form of LiNi_{y}Mn_{2-y}O₄ particles manufactured in a hot gas flow from a raw material mixture in the form of a solution or dispersion, wherein the raw material mixture comprises at least one of the elements lithium, nickel and/or manganese.

16. The mixed oxide powder according to claim 15, wherein the mixed oxide powder is manufactured in a hot gas flow from a raw material mixture in the form of a solution or dispersion, wherein the raw material mixture comprises at least two of the elements lithium, nickel and/or manganese.

17. The mixed oxide powder according to claim 15, wherein the raw material mixture in the form of a solution or dispersion is manufactured from at least one salt and/or salt mixture.

18. The mixed oxide powder according to claim 15, wherein the mixed oxide powder comprises one or more dopants selected from the elements magnesium, aluminium, titanium, vanadium, chromium, iron, cobalt, copper, zinc, silicon, zirconium, ruthenium, rhodium, palladium, silver, and platinum.

19. The mixed oxide powder according to claim 15, wherein the mixed oxide powder has an electrochemical capacity of larger than 100 mAh/g at 0.1 C.

20. The mixed oxide powder according to claim 15, wherein the mixed oxide powders have a particle size of 0.5 μm to 100 μm.

21. The mixed oxide powder according to claim 15, wherein the mixed oxide powders have a cubic crystal system.

22. The mixed oxide powder according to claim 15, wherein the mixed oxide powder is manufactured according to a method for manufacturing mixed oxide powders comprising the steps of:
(a) producing a raw material mixture,
(b) bringing the raw material mixture into a hot gas flow for thermal treatment in a reactor,
(c) forming particles of the mixed oxide powder, and
(d) bringing the particles of the mixed oxide powder which are obtained in the steps (b) and (c) out of the reactor.
